(19) United States
(12) Patent Application Publication
(10) Pub. No.: US 2019/0310711 A1
(43) Pub. Date: Oct. 10, 2019

(54) METHOD AND SYSTEM FOR SENSORY SIMULATION IN VIRTUAL REALITY TO ENHANCE IMMERSION

(71) Applicant: MAJORMEGA, LLC, Lititz, PA (US)

(72) Inventors: Michael Richard BRIDGMAN, Lancaster, PA (US); Sean HENNESSEY, Lancaster, PA (US)

(21) Appl. No.: 16/376,788

(22) Filed: Apr. 5, 2019

Related U.S. Application Data
(60) Provisional application No. 62/653,931, filed on Apr. 6, 2018.

(51) Int. Cl. G06F 3/01; A63F 13/28

(52) U.S. Cl. CPC G06F 3/016; G06F 3/011; G05D 23/1917; A63F 2300/8082; A63F 13/28

(57) ABSTRACT

A multi-sensory virtual reality system enhances a user's 3-D environment immersion and minimizes the chance of immersion breaking events with the multi-sensory virtual reality system including a headset, a data process system, a dynamic platform, and an HVAC system. The headset includes a display unit configured to display 3-D virtual environment. The data process system is configured to generate data representing motion, wind, and/or temperature simulations associated with a 3-D environment events and a user's actions. The dynamic motion platform is configured to produce motions associated with the 3-D environment events and the user's actions based on the processed data. The HVAC system is configured to produce air movement associated with the 3-D environment events and the user's movements based on the processed data. The virtual reality system also provides for temperature adjustments associated with the 3-D environment events and the user's actions.

### RELATED APPLICATIONS

This application claims the benefit of, and priority to, U.S. App. No. 62/653,931, filed Apr. 6, 2018, which is hereby incorporated by reference in its entirety.

### FIELD

The present invention is directed to sensory stimulation during virtual reality immersion.

### BACKGROUND

Even though virtual reality experiences may provide a convincing immersive experience, when the simulation is real-time based on user input, there are several factors that can break this immersion and remind users that they are not in the simulated environment, thereby diminishing the immersive experience. Examples of immersion breakers can include riding in a vehicle without feeling road bumps or g-forces while the vehicle is turning, or an explosion near the user without feeling the heat or force.

What is therefore needed is a virtual environment supplemented with multi-sensory stimulation to enhance immersion and minimize the chance of immersion breaking events.

### SUMMARY

In an exemplary embodiment, a multi-sensory virtual reality system includes a dynamic platform having at least one actuator configured to produce interactive movement based on a user's input and events within a virtual reality system.

In one an embodiment, a multi-sensory virtual reality system enhances a user's 3-D environment immersion and minimizes the chance of immersion breaking events with the multi-sensory virtual reality system including a headset, a data process system, a dynamic platform, and an HVAC system. The headset includes a display unit configured to display 3-D virtual environment. The data process system is configured to generate data representing motion, wind, and/or temperature simulations associated with a 3-D environment events and a user's actions. The dynamic motion platform is configured to produce motions associated with the 3-D environment events and the user's actions based on the processed data. The HVAC system is configured to produce air movement associated with the 3-D environment events and the user's movements based on the processed data. The virtual reality system also provides for temperature adjustments associated with the 3-D environment events and the user's actions.

Other features and advantages of the present invention will be apparent from the following more detailed description of the preferred embodiment which illustrates, by way of example, the principles of the invention.

### BRIEF DESCRIPTION OF THE DRAWINGS

FIG. 1 is a top-down view of an illustrative embodiment of the virtual reality system of the present invention.

FIG. 2 is a front side view of an illustrative embodiment of the virtual reality system of FIG. 1.

FIG. 3 is a side perspective view of another illustrative embodiment of a virtual reality system.

FIG. 4 is a perspective view of an illustrative portion of a game station used in the virtual reality system.

FIG. 5 is a perspective view of an illustrative game controller used in the virtual reality system.

FIG. 6 is a side view of an illustrative embodiment of the virtual reality system.

FIG. 7 is a schematic of an embodiment of a safety system in a first condition.

FIG. 8 is a schematic of an embodiment of the safety system in a second condition.

FIG. 9 is a side perspective view of an illustrative spectator play feature used in the virtual reality system.

FIG. 10 is a top perspective view of an illustrative virtual reality system.

FIG. 11 is an illustrative flow chart showing the interaction of various components of an embodiment of the virtual reality system.

FIG. 12 is an illustrative flow chart of the overall operation of an embodiment of the virtual reality system.

FIG. 13 is an illustrative flow chart of the operation of the spectator play feature of an embodiment of the virtual reality system.

### DETAILED DESCRIPTION

Provided is a system that provides multi-sensory stimulation during a virtual reality experience. The system generates stimulation based on the user's input in real-time, which can enhance the immersion experience of the user.

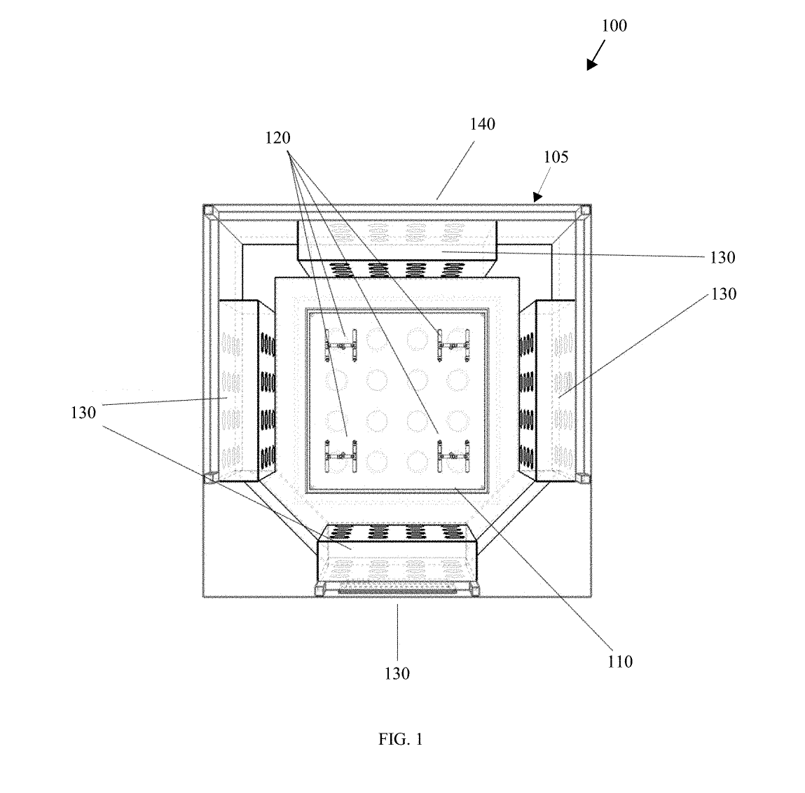

FIGS. 1-3 depict various views of an embodiment of a virtual reality system 100. The system 100 can include a game station 105 which can further include: a dynamic motion platform 110; one or more game controllers 120; an HVAC system, such as fans, wind generator(s), and/or a heating system 130; one or more walls 140; and/or a ceiling 150. The game station 105 can provide immersive visual, audible, motion cueing, vibrational, heat, wind, air movement and/or smell inputs to a user.

In the example of FIG. 1, the game station 105 includes a dynamic motion platform 110. The dynamic motion platform 110 shown in FIG. 1 is located near a center region of the game station 105. This may position a user to receive stimuli from devices located on the walls 140 and/or ceiling 150 more efficiently. The dynamic motion platform 110 can synchronously tilt, rotate and/or vibrate with the events happening in a dynamic 3-D environment that is being visually perceived by a user. The game station 105 can integrate actions conducted by the user, which may allow the user to feel as if he or she were actually moving in accordance to what her or she is experiencing or displayed in the dynamic 3-D environment, thus enhancing, rather than breaking, the immersive experience. The dynamic motion platform 110 can actuate a large range of motion that can simulate opposing forces, deliver high-impact acceleration, locomotion and any combination thereof. The dynamic motion platform 110 provides movement encompassing three degrees of freedom. The dynamic motion platform 110 may roll, pitch, move forward, backward, left, right, up, down and/or rotate. The range of movements can allow the user to experience dynamic 3-D environment events, such as, for example, a vehicle that experiences a bump in the road, a shift in gears, g-force, acceleration, braking and/or impact.

It should be recognized that the dynamic motion platform 110 can be in many forms. The dynamic platform can comprise a surface for the user to stand on. Some non-limiting examples may include a flat surface, such as base, mat, floor or the like upon which the user can stand. The flat surface dynamic motion platform 110 may include other shapes such as square, triangular, circular, rectangular or the like. The dynamic platform can alternatively include an element for the user to sit on. In some non-limiting examples, the dynamic platform with a seating element can include a chair, stool, pedestal, bench, recliner, pew or the like.

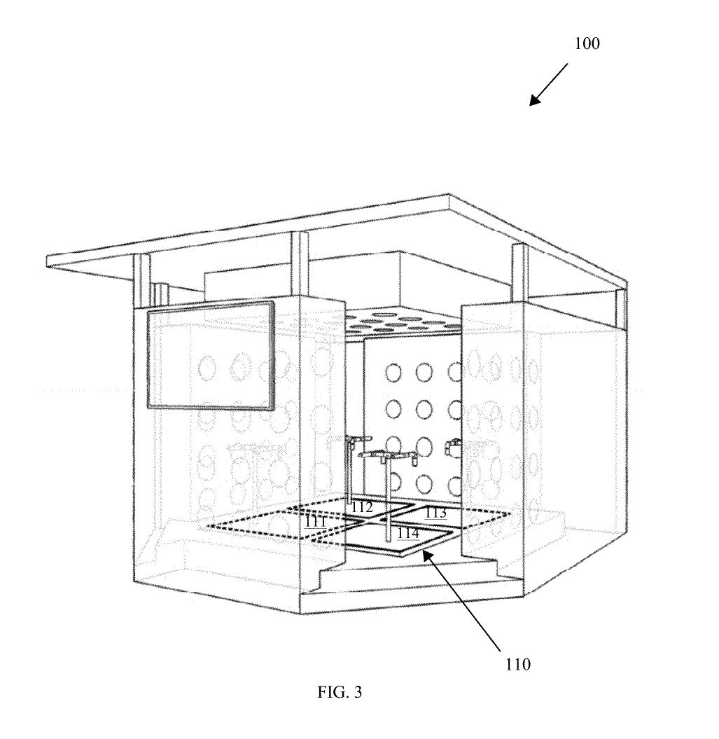

The dynamic motion platform 110 may be configured to move as a single platform to provide a group of users a similar immersive simulation, such as riding in the same vehicle. Alternatively, the dynamic motion platform 110 may include platform regions 111, 112, 113, 114 configured to move independently of one another, such as shown in FIG. 3. The independently configured platform regions 111, 112, 113, 114 may correspond to the location of individual users to provide a customized virtual reality experience to each user. It will be appreciated that while FIG. 3 illustrates a game station 105 configured for one to four users, the game station 105 may be configured to accommodate more than four users.

The system can include one or more game controllers 120, which in some embodiments are mounted to the platform 110. Thus, it will be appreciated that the mounted game controllers 120 serve the dual purpose of a game controller to interact with the 3-D environment while also providing an anchor for the user to hold on to during the ride and accompanying movements of the platform 110, some of which may be sudden and/or jarring to aid in enhancing the immersive experience.

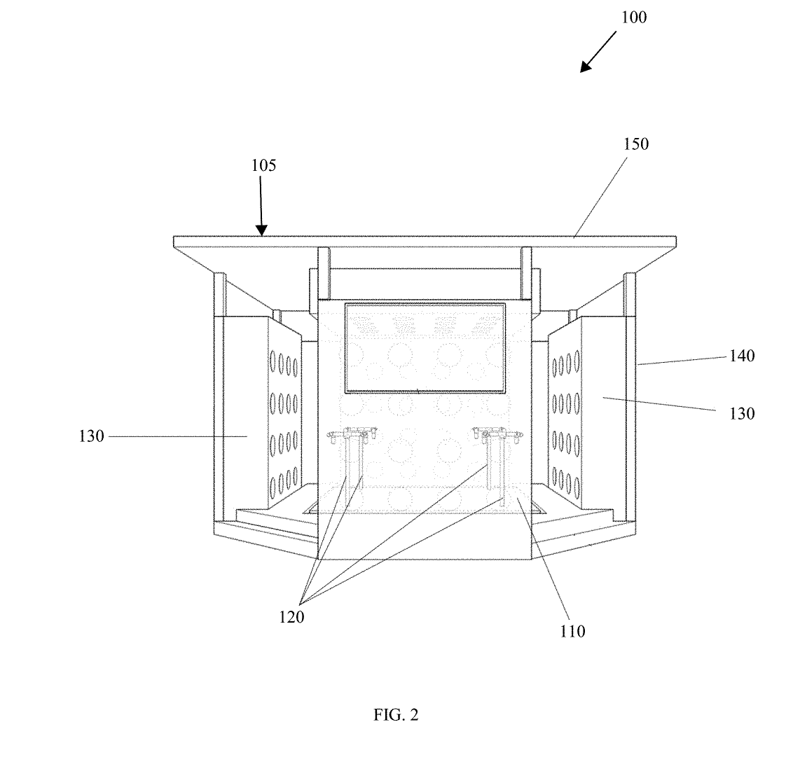

In some embodiments, each user has their own mounted game controller 120. FIG. 2 depicts one example of how the mounted game controllers 120 can be configured. The mounted game controllers 120 can contain two or more hand grips centered around a pivot point. It should be recognized that the mounted game controller 120 can be in many forms. In some non-limiting examples, the controller can simulate: a machine gun, a sword, a shield, a fishing pole, gloves or the like. The mounted game controller 120 can contain buttons, triggers, switches or the like, which may function as physical interactive components, allowing the user to interact with the 3-D environment. The mounted game controller 120 may contain sensors to detect the presence of the user's hand(s), as well as hand movement and to measure forces exerted by the user. The mounted game controller 120 can be configured to relay real-time feedback, such as forces, vibrations or motions, to the user based on user's input and events in the 3-D environment.

The mounted game controller 120 can also pivot to allow the user to move and more realistically interact with the virtual environment. In some embodiments, the mounted game controller may pivot through an arc of at least 180 degrees, 190 degrees, 200 degrees, 240 degrees, 300 degrees, 330 degrees, and/or 360 degrees. The mounted game controller 120 may also be adjustable vertically to provide a more realistic and ergonomic position for the user.

The game station 105 can include one or more HVAC systems 130. It will be appreciated that the HVAC system 130 may be one or more individual components such as individually controlled wind generator(s), such as fans and/or direct blowers heating units, and the like, and does not necessarily or even typically rely on interconnected, ducted systems. In the example of FIGS. 1-3 the game station 105 includes five wind HVAC systems 130 positioned as integral to four walls 140 and the ceiling 150 of the cubical game station 105. In some embodiments, each of the four walls 140 includes HVAC systems 130 in the form of a plurality of individually controlled fans or direct blowers and which may be single, multiple, or variable speed. In a presently preferred embodiment, heat is directed from the ceiling while wind is directed from the walls.

It will be appreciated that additional configurations of the game station 105 are possible, such as using a single wall, two walls, three walls or more walls, such as eight walls to form an octagon, all of which configurations can be used to provide a desired wind source and that wind sources may be directed upwards through holes in the dynamic motion platform 110 (i.e., the floor). In an alternate embodiment, the game station 105 may be configured as a cylinder, sphere or combinations thereof allowing the HVAC system 130 to provide air movement from substantially any direction relative to the user. The direct blowers or other HVAC systems 130 are situated in the walls 140 in a configuration to help ensure a user experiences a continuity of air flow so as not to break the immersive experience even as the user moves, such as pivoting about the game controller 120.

The HVAC system 130 may produce a diverse combination of air shots, inducing a vivid sensation of a gunshot. The HVAC system 130 can receive data produced by a data processor and can be switched on or off or otherwise controlled to generate air motion, such as wind, air blast, air shot or the like, based on the user's input and events within the 3-D environment. The HVAC system 130 can also generate heat based on the user's input and events within the 3-D environment, which may enhance the user's perception of immersion in the virtual experience. It should be recognized that the position of the HVAC system 130 is not limited to the walls and ceiling.

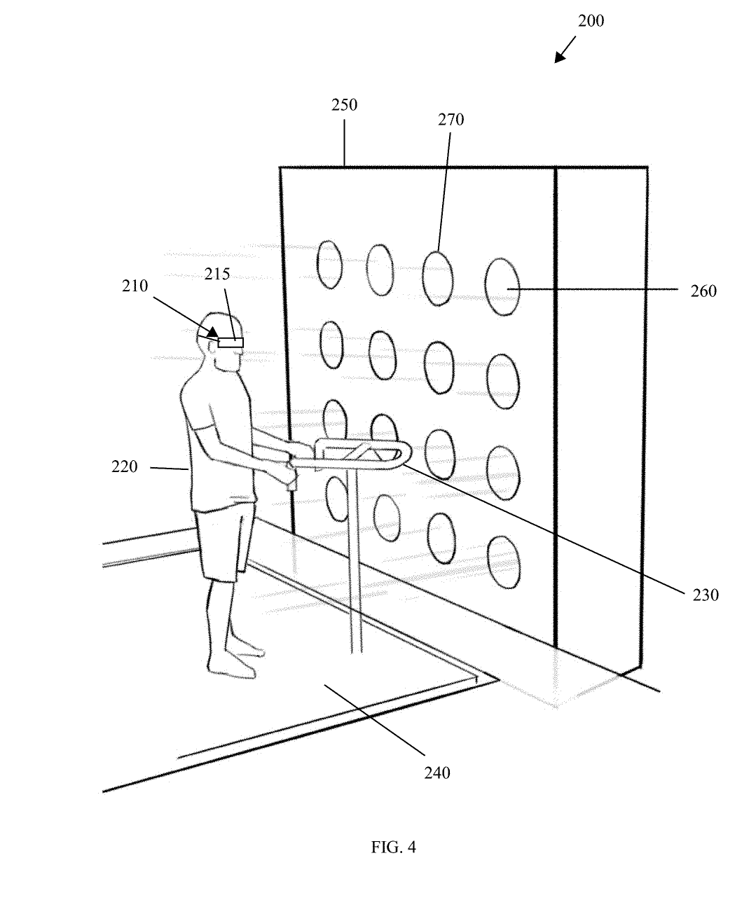

An embodiment of an active/in-play game station 200 is illustrated in FIG. 4 in which a user 220 is engaged in the immersive experience and participating in the perceived 3-D environment. The game station 200 can be communicatively connected to one or more headsets 210 depending on the number of users. The headset 210 can include a display unit 215 configured to display a live rendering of the virtual environment to the user 220, which may include, for example, a dynamic 3-D environment or an animated video. In some embodiments, each user 220 may have their own headset 210. The headset 210 can display a dynamic 3-D environment in a first-person perspective, which can allow the users to have enhanced immersion of the 3-D environment.

In some embodiments, the headsets 210 can also provide audio stimuli that accompanies the dynamic 3-D environment and the motions of the dynamic platform. In some embodiments, the audio stimuli can be provided by a non-headset or outside source (e.g. that is not integrated into the headsets). In some embodiments, the audio stimuli can be provided by the headset 210 and an outside source (e.g., speakers not integrated into the headset). The headset 210 may further include a motion-sensing unit that includes sensors to detect and track movements of the user's head. The headset 210 may be communicatively connected to the game station 200 via a wired or wireless connection. In some embodiments, the headset 210 is wirelessly connected to the game station 200.

The headset 210 may communicate with the game station 200 to allow the automatic adjustment of a mounted game controller 230 to provide a more ergonomic interaction for the user 220. In some embodiments, the user 220 may further adjust the mounted game controller 230 by interacting with controls mounted on the mounted game controller 230.

During play, the game station 200 can impart various stimuli to the user 220 based on game events and the position of the user 200. The game station 200 can impart stimuli via a dynamic motion platform 240, and/or one or more wall or ceiling sections 250. The one or more wall sections 250 may house part or all of an HVAC system configured to move and/or heat the air surrounding the user 220. In an embodiment, the HVAC includes one or more blowers as previously described, in communication with one or more controllers. In one embodiment, the fan operation may be regulated by controlling the voltage applied to the fan motor. The HVAC system may also include one or more heating elements in communication with one or more controllers. The HVAC system may deliver the air-based stimuli to the user 220 via one or more ports 260. In some embodiments, each port 260 may be associated with an individually controlled blower. In some embodiments, the ports 260 may be integral to the wall or ceiling sections 250. In a further embodiment, the dynamic motion platform 240, such as the floor, may also include an HVAC system configured as described above. The ports 260 may be sized and positioned about the game station 200 to ensure positional continuity of air flow is experienced even as the user moves during game play.

The one or more wall or ceiling sections 250 may additionally include visual enhancements that may improve the experience for an observer of the game. In some embodiments, one or more of the ports 260 may include edge lighting 270. In one embodiment, the edge lighting 270 may be operated continuously. In one embodiment, the edge lighting 270 may be operated in conjunction with the fan associated with the one or more port 260.

In some embodiments, the dynamic motion platform 240 and the one or more wall or ceiling sections 250 may be modular in configuration. It will be appreciated that modular components may allow the virtual reality system 100 to be customized for both the number of users 220 and the overall user 220 experience, such that multiple users may all be participating in the same virtual environment and cooperating toward achieving a common goal.

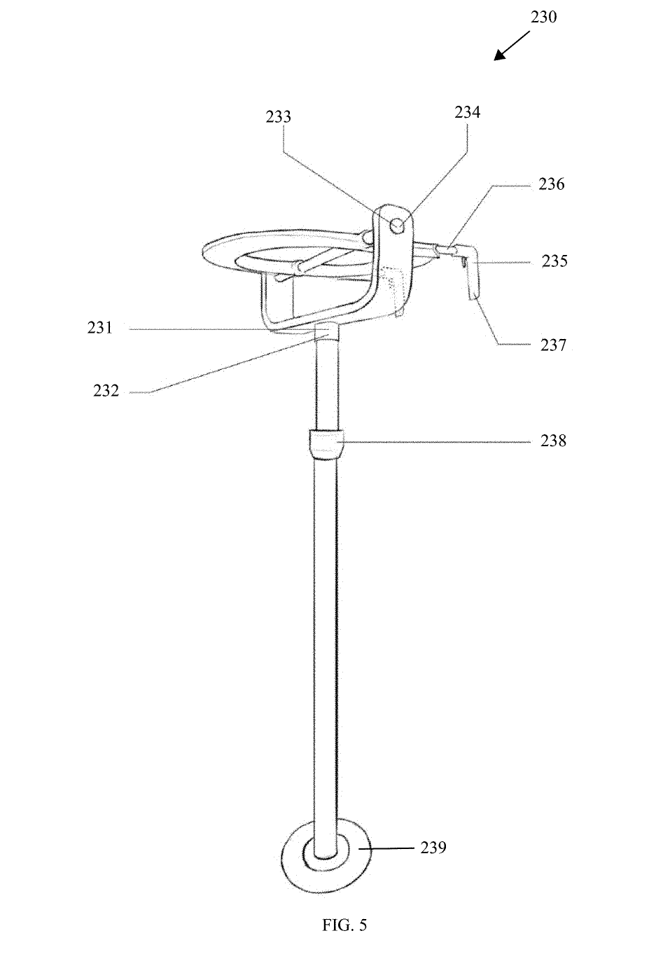

An expanded view of the mounted game controller 230 is shown in FIG. 5. In the example of FIG. 5, the rotational position of the mounted game controller 230 is physically tracked in real time, using an encoder 231. The mounted game controller 230 tilt position is physically tracked in real time, using an encoder 234. In an embodiment, the left- and right-hand grips 235 are actuated independently by solenoids 236 in response to player input and/or events happening in the game, for example to permit a player to feel recoil when using the game controller 230 to launch a projectile such as a grappling hook or a bullet. Additionally, the left- and right-hand grips 235 vibrate independently in response to player input and/or events happening in the game.

Hand sensors 237 may be embedded in the hand grips, tracking a player's hand. When any player's hands are not holding at least one hand grip 235 at any time during gameplay, the player is notified, such as visually and/or audibly, to hold onto the grips. In an embodiment, if a player's hand is outside the proximity of the hand sensors 237 for an extended period of time, the game will safely pause until all player's hands are properly holding onto the hand grips 237. In some embodiments, if both player's hands are detected to be outside the proximately of the hand sensors, the game may immediately or promptly pause without an advance warning to reduce the risk of the user falling during platform movement.

In an embodiment, the height of the mounted game controller 230 may be adjusted to accommodate a player's height at the beginning of the game via actuator 238. Furthermore, in some embodiments, the rotational resistance of the game controller 230 may be dynamically increased or decreased in real time by a first magnetic clutch 232 in response to player 220 input and/or events happening in the game. In an embodiment, the tilt resistance is dynamically increased or decreased in real time by a second magnetic clutch 233 in response to player input and/or events happening in the game.

In some embodiments, visual enhancements may be incorporated into the mounted game controller 230 to enhance an observer's experience. In some embodiments, lighting 239 may be added to the base of the mounted game controller 230. In one embodiment, the color of the light may be individually selected to represent the player operating the mounted game controller 230.

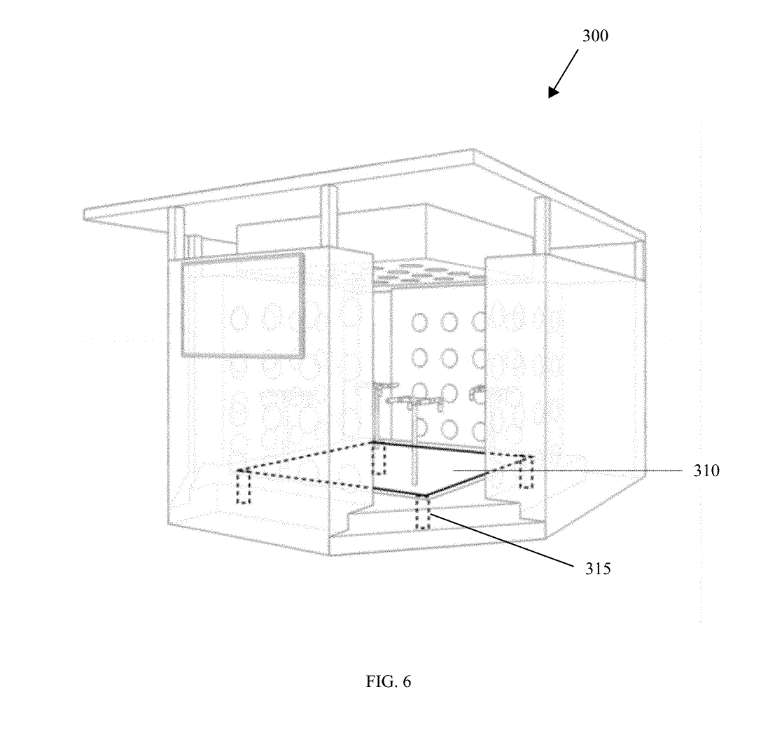

An embodiment of a game station 300 is shown in FIG. 6. In the example of FIG. 6 a dynamic motion platform 310 including linear actuators 315 is configured to impart motion to a user within the game station 300. In the example of FIG. 6 the linear actuators are placed at the corners of the dynamic motion platform 310. This actuator configuration allows for three degrees of freedom: heave, pitch and roll. In addition, the actuators 315 can additionally vibrate at varying frequencies. The actuators are operated in real time based on gameplay and player input. Other configurations of the platform and actuators may be used. For example, the dynamic motion platform 310 may include regions configured to move independently on one another, as described in FIG. 3 above. To allow for independent movement, each independently moving region may have one or more independently controlled actuators which move the region based on in game events and user inputs. Additionally, the shape of the dynamic motion platform 310 or its sub-regions may be varied to customize the user experience. Suitable shapes include squares, rectangles, circles, hexagons, and octagons, for example. In one embodiment, the shape of the dynamic motion platform 310 or its sub-regions possess at least one axis of symmetry. In an embodiment, the actuators 310 may be placed in communication with the dynamic motion platform 310 based on the one or more axis of symmetry.

As the dynamic motion platform 310 is actuated it will move relative to a stationary portion of the floor. As the dynamic motion platform 310 moves, a gap between the dynamic motion platform 310 and floor may be formed in which a user, operator, or spectator could inadvertently insert an object or body portion. To prevent potential loss or injury, a safety system 400 may be used in conjunction with the dynamic platform 310.

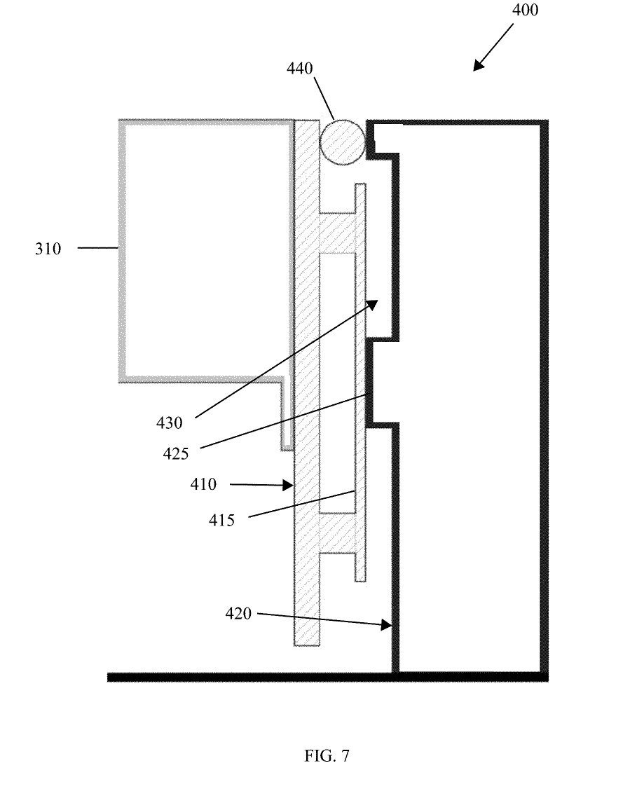

FIG. 7 illustrates an embodiment of the safety system 400 in an unactuated configuration. The dynamic motion platform 310 is positioned in contact with a spacer unit 410 attached to a wall or floor member 420, which prevents a gap from being present between the spacer unit 410 and dynamic motion platform 310. In some embodiments, the spacer unit 410 includes leaf spring 415 which may contact a wall or floor member extension 425. The position of the wall or floor member extension 425 may form a cavity 430 which provides an open region in which the spacer unit 410 may move within during operation of the dynamic motion platform 310. The safety system 400 may additionally include a compressible element 440 which allows the position of the spacer unit 410 to shift as the dynamic motion platform 310 moves.

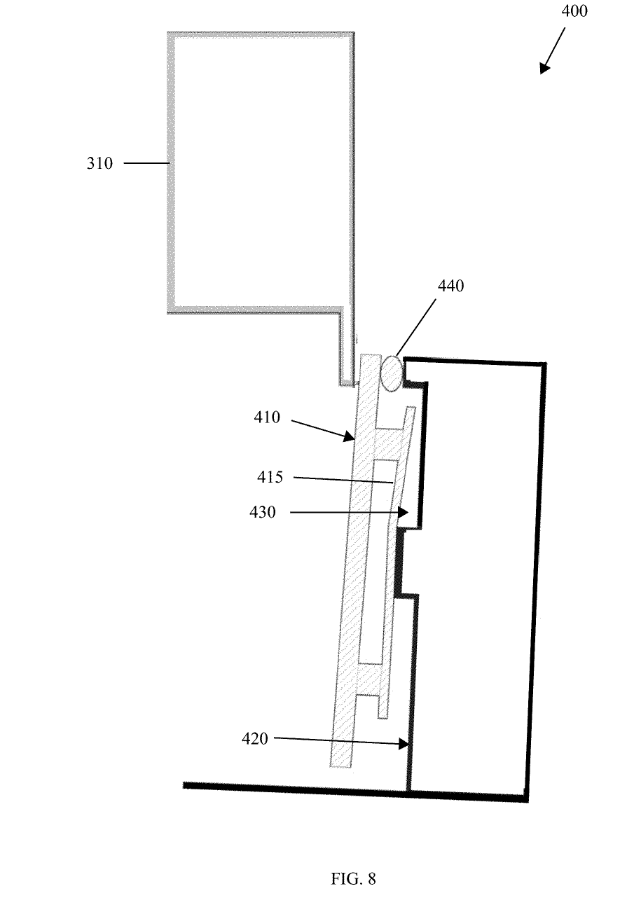

FIG. 8 illustrates an embodiment of the safety system 400 in an actuated configuration, with at least a portion of the platform extended from the floor such as might occur during a programmed tilt or heave, for example. The compressible element 440 is deformed, relative to the unactuated position, to allow the spacer unit 410 to move relative to the position of the dynamic motion platform 310 thus remaining in contact with the dynamic motion platform 310 to prevent or minimize the formation of a gap. The leaf spring 415 is also deformed, relative to the unactuated position, and at least partially moved into the cavity 430, thus allowing the spacer unit 410 to freely move to remain in contact with the dynamic motion platform 310.

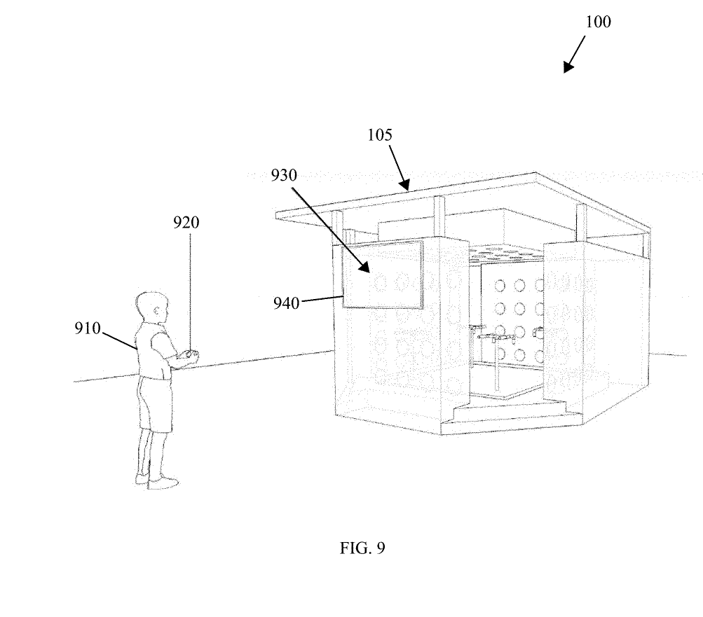

The virtual reality system 100 may additionally allowing participation in the game by users external to the game station 105. FIG. 9 illustrates an embodiment in which one or more external users 910 can provide inputs to the game which directly affect the experience of the users in the game station 105, for example by placing positive or negative mystery boxes or could otherwise virtually impact the 3-D environment. In the example of FIG. 9 the external user 910 can interact with the game wirelessly via an app on a handheld device 920, such as a cell phone or tablet. In an embodiment, the external user 910 may select game options on their mobile device 920 and see the ongoing game play, including the effects of their input, on one or more display screens 930. The one or more display screens 930 may also include additional visual effects that draw attention to events in the game and the actions of the one or more external users 910. In some embodiments, the visual effects may be presented by a light bar 940 along some or all of the periphery of the one or more display screens 930.

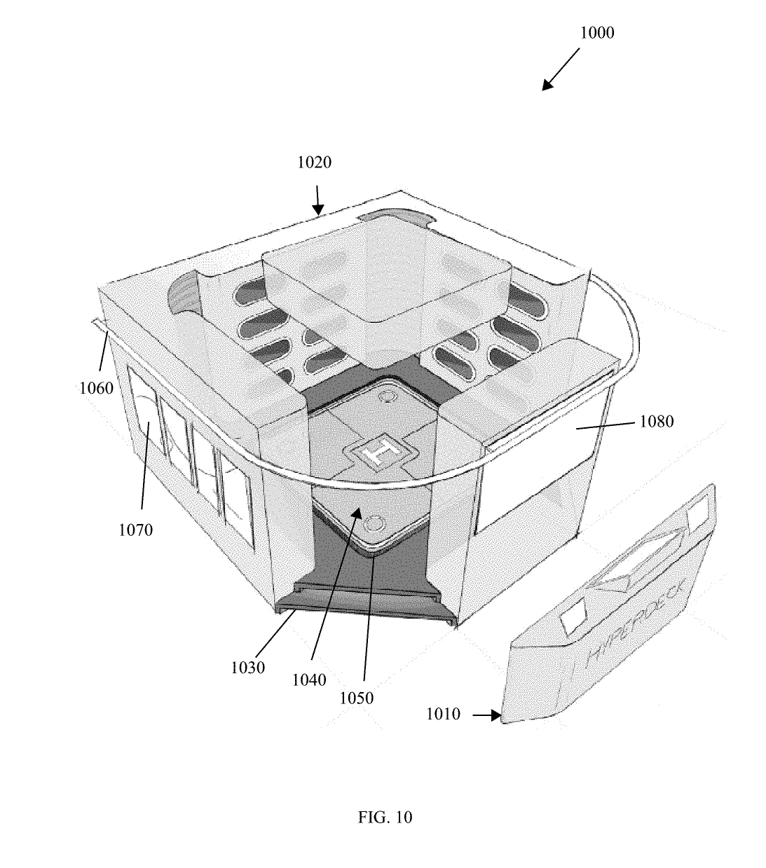

An embodiment of a virtual reality system 1000 is illustrated in FIG. 10. In the example of FIG. 10, the virtual reality system 1000 includes a game station control module 1010 which allows an operator to manage the operation of the virtual reality system 1000. In some embodiments, the operator may add or remove users, begin or end the game, select a game, display the progress or results of a game, add or remove external users, alter visual enhancement features, configure the stimuli associated with events in the game, and otherwise manage the user, external user, and spectator experience.

The virtual reality system 1000 further includes a game station 1020 which provides an enclosure meeting the F24 International Ride Standard. In some embodiments, this will result in the game station 1020 entrances and/or exits closing while users are participating in the game. The users may be directed to enter and/or exit the game station 1020 via one or more defined ingress or egress pathways 1030 which may include stairs, ramps, or other walkways. The pathways 1030 may additionally be lighted, such as around the perimeter or from behind to enhance the user experience and facilitate safety.

The internal area of the game station 1020 may also include visual enhancements to improve the user experience and facilitate safety. For example, the dynamic motion platform 1040 may include platform lighting 1050 along the periphery of the moveable platform to enhance the visual presentation while advising users of the movable regions of the game station 1020.

The external faces of the game station 1020 may also include visual enhancements to facilitate the viewing and interaction of external users and spectators. In some embodiments, the game station 1020 may include lighting or messaging displays 1060 around a top region of the game station 1020. The external faces of the game station include various displays, such as, external user interactive displays 1070 and/or general game status displays 1080 which may display an overall view of ongoing play or game results. The content displayed may be controlled by the operator via the game station control module 1010. In some embodiments, the virtual reality system 100 may include the virtual reality system 1000.

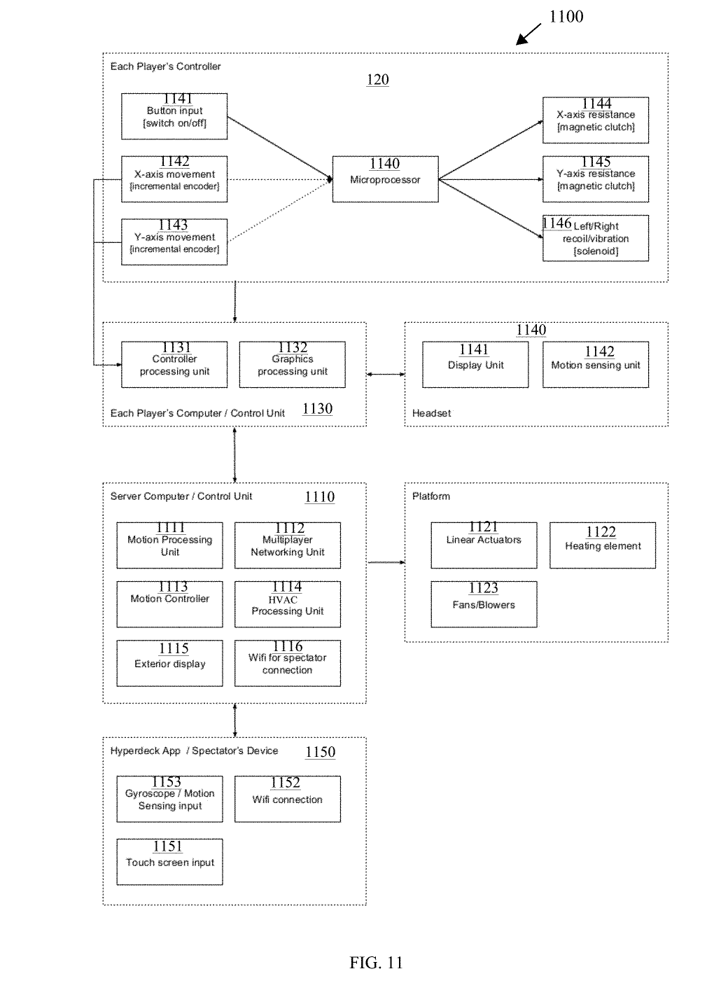

The virtual reality system 100 may be managed by a management control system 1100, as shown in FIG. 11. The management control system 1100 includes a central control unit 1110 having microprocessors, memory, and communication hardware configured to comprise a motion processing unit 1111, a multiplayer processing unit 1112, motion controller 1113, HVAC processing unit 1114, an exterior display unit 1115, and spectator interaction unit 1116.

The central control unit 1110 is in communication with a platform control unit 1120 which regulates the operation of the dynamic motion platforms 110 and HVAC systems 130. The platform control unit 1120 may include a platform control unit 1121, a heating control unit 1122, and/or a fan control unit 1123.

The central control unit 1110 is additionally in communication with one or more user experience control units 1130. In some embodiments, the user experience control units 1130 may be integral with the mounted game controllers 120. The user experience control units 1130 independently regulate the visual stimuli presented to each user. The user experience control units 1130 may include a controller processing unit 1131 and a graphics processing unit 1132. The controller processing unit 1131 may receive activity and positional data from the mounted game controller 120 which allows the controller processing unit to interpret user inputs and location via the position and inputs received by the mounted game controller 120. The mounted game controller 120 may include a microprocessor 1140 which can process data regarding button input 1141, translational movement, rotational movement, and height received as a result of user actions, such as via an x-axis encoder 1142 and y-axis encoder 1143. The microprocessor 1140 may optionally additionally process the data to cause the mounted game controller 120 to provide active feedback to the user. In some embodiments, the feedback may include increased x-motion resistance via an x-motion resistance unit 1144, increased y-motion resistance via a motion resistance unit 1145, or vibration via a vibrational unit 1146.

The controller processing unit 1131 may then communicate the data to the graphics processing unit 1132 which integrates the user actions into the event display. The graphics processing unit 1132 may then communicate the current events viewable by the user to the user's headset 1140. The headset 1140 includes a display unit 1141 which renders the events as visual information and displays them to the user. The headset 1140 may also collect positional data from the user. The headset 1140 may include a motion sensing unit 1142 that allow the headset 1140 to determine the position and thus the point of view of the user allowing a more accurate rendering of the event views.

The central control unit 1110 is further configured to process the integrated event data for display to a spectator or external user. The central control unit 1110 may communicate with a spectator's device 1150 allowing them a more immersive experience and/or additionally allowing them to become an external user. The central control unit 1110 is additionally configured receive external inputs from an external user based on touch screen input 1151 via a wireless connection 1152. In an optional embodiment, the central control unit 1110 may receive positional data from the external user via a motion sensing unit 1153 allowing the external user increased interaction in the events of the game.

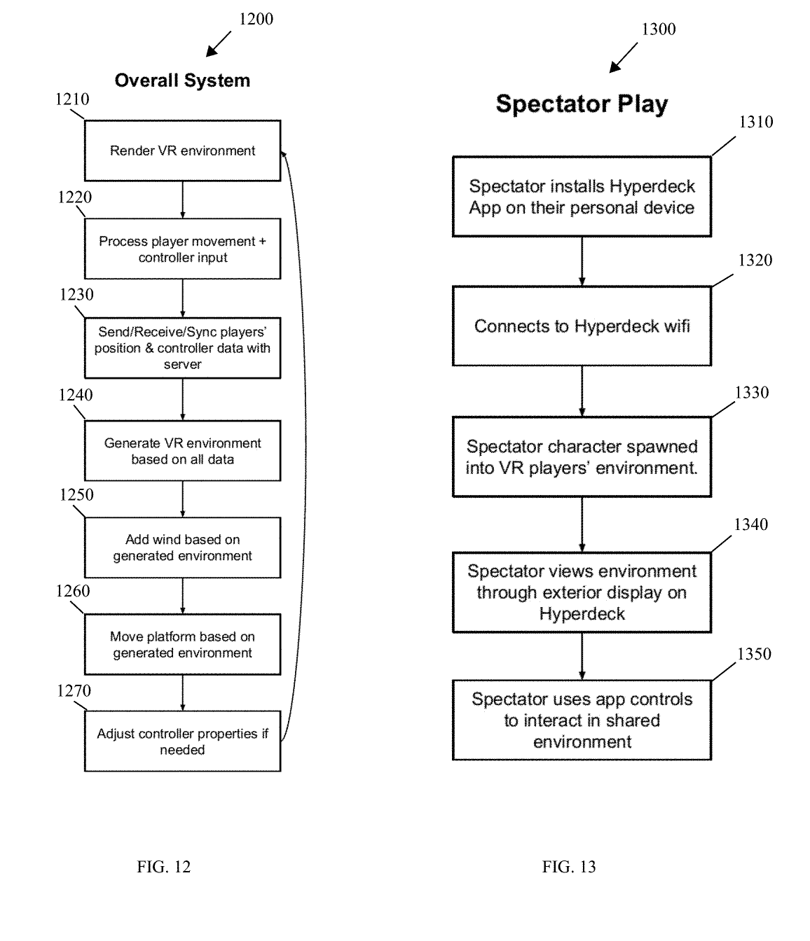

FIG. 12 illustrates an embodiment of a method of providing a virtual reality experience 1200. At block 1210, the virtual reality system renders a virtual reality environment. In some embodiments, a graphics processing unit determines the visual and audio stimuli to be experienced by a user. The graphics processing unit communicates with an audio and/or visual display unit, such a user's headset to render the virtual reality environment to the user.

At block 1220, the virtual reality system receives data based on user movement and controller inputs. Subsequently, at block 1230 the virtual reality system synchronizes the data received and at block 1240, generates a virtual reality environment based on the data set.

At block 1250, the virtual reality system adds wind to the user experience based on the generated environment. The virtual reality system also, at block 1260, moves the dynamic motion platform based on the generated environment. The virtual reality system may additionally, at block 1270 adjust the any controller properties as needed.

Although shown linearly, it will be appreciated that the flowchart of FIG. 12 is exemplary only and that the dynamic nature of the system may result in some of the various inputs being received in any order and/or simultaneously.

FIG. 13 illustrates an embodiment of a method 1300 that allows spectators to interact with the events of the game. At block 1310, a spectator installs a game station application on their personal device or optionally on a shared device associated with the game station 105. At block 1320, the spectator connects to the game station 105 via wireless communication, such as WiFi. At block 1330, the spectator optionally has a character spawned into the virtual reality user environment. At block 1340, the spectator views the virtual reality environment through an exterior display on the game station. At block 1350, the spectator interacts with the shared environment via the game station application by the optional character spawning, or, in some embodiments, via a “Hand of God” arrangement in which the spectator can deliver rewards or punishments.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A multi-sensory virtual reality system, comprising a dynamic platform including at least one actuator configured to produce interactive movement based on a user's input and events within a virtual reality system.

2. The system of claim 1, further comprising one or more headsets including a display unit configured to display a virtual reality environment.

3. The system of claim 2, wherein the display unit is additionally configured to produce sounds based on the user inputs and events within the virtual reality system.

4. The system of claim 2, further comprising one or more wind units configured to generate wind incident upon a user based on the user inputs and events within the virtual reality system.

5. The system of claim 4, wherein the wind units are individually controlled.

6. The system of claim 1, further comprising a confined space that includes one or more walls and a ceiling.

7. The system of claim 6, wherein the confined space defines an enclosure with a defined ingress and egress.

8. The system of claim 1, wherein the dynamic platform produces three-dimensional interactive movement based on a user's input and events within a virtual reality system.

9. The system of claim 1, further comprising a safety feature which prevents a user's body portion from entering a gap produced by the movement of the dynamic platform.

10. The system of claim 10, wherein the safety feature includes a leaf spring.
